(19) United States
(12) Patent Application Publication
(10) Pub. No.: US 2015/0071085 A1
(43) Pub. Date: Mar. 12, 2015

(54) NETWORK GATEWAY FOR REAL-TIME INSPECTION OF DATA FRAMES AND IDENTIFICATION OF ABNORMAL NETWORK BEHAVIOR

(71) Applicant: ClioTech Inc., Wilmington, DE (US)

(72) Inventor: Larisa TSIRINSKY-FEIGIN, Tel-Aviv (IL)

(21) Appl. No.: 14/543,244

(22) Filed: Nov. 17, 2014

Related U.S. Application Data
(63) Continuation-in-part of application No. 14/255,605, filed on Apr. 17, 2014.
Application No. 14/255,605 is a continuation of application No. 12/962,420, filed on Dec. 7, 2010, now Pat. No. 8,705,541.
Application No. 12/962,420 is a continuation of application No. PCT/US2009/043887, filed on May 14, 2009.
(60) Provisional application No. 61/060,270, filed on Jun. 10, 2008.

(51) Int. Cl. H04L 12/26; H04L 12/721

(52) U.S. Cl. CPC H04L 43/0823; H04L 45/66
USPC 370/242

(57) ABSTRACT

A network gateway and method for inspecting frames in a communication network are provided. The method includes transparently intercepting frames flowing in the communication network; inspecting each of the intercepted frames to detect at least one abnormal event; upon identifying an intercepted frame as including at least one abnormal event, determining if at least one network service can be assigned to the abnormal event identified in the intercepted frame in order to mitigate the abnormal event; and processing each intercepted frame according to at least one service associated with the frame.

### CROSS REFERENCE TO RELATED APPLICATIONS

The present application is a continuation-in-part of U.S. patent application Ser. No. 14/255,605 filed Apr. 17, 2014, now pending. The Ser. No. 14/255,605 application is a continuation of U.S. patent application Ser. No. 12/962,420 filed on Dec. 7, 2010, now U.S. Pat. No. 8,705,541, which is a continuation of International Patent Application No. PCT/US2009/043887 filed on May 14, 2009. The PCT/US2009/043887 Application claims the benefit of U.S. provisional application No. 61/060,270 filed on Jun. 10, 2008. The contents of the above-mentioned applications are herein incorporated by reference.

### TECHNICAL FIELD

The invention relates generally to data networks, and more particularly to network devices for detecting abnormal events in data networks.

### BACKGROUND

Transport control protocols (TCPs) are used extensively by many network communication applications including, for example, the World Wide Web (WWW), e-mail, file transfer protocols (FTPs), streaming media applications, and the like. The TCP is a reliable stream delivery service that guarantees delivery of a stream of data sent from one host to another without duplicating or losing data. The TCP implements a positive acknowledgment technique that includes retransmission of packets to guarantee reliability of packet transfers. This technique requires the receiver to respond with an acknowledgment message as it receives the packet. When such a message is not received within a predefine time window, the sender retransmits the packet. As the TCP is optimized for accurate delivery, the protocol sometimes incurs relatively long delays and extensive bandwidth usage. Therefore, the TCP is not particularly suitable for applications where real-time delivery is needed.

A user datagram protocol (UDP) is usually utilized in applications requiring timely delivery. The UDP does not guarantee reliability of ordering of packets and, thus, packets (or datagrams) may arrive out of order, appear duplicated, or go missing without notice. The UDP is faster and consumes less bandwidth than the TCP, as the overhead of checking when every packet actually arrives is eliminated.

In the related art, network devices (e.g., gateways, switches, routers, and so on) implementing network communications using either a UDP or a TCP cannot provide efficient mechanisms to support communication over special-purpose time-critical and mission-critical networks where both timely and guaranteed delivery are essential. Typically, such networks are utilized in military applications, communication between ground and aerial devices, and so on.

An example for a time-critical and mission-critical network is an IP military network that requires more complex architecture than a civilian IP network. Another example for a time-critical and mission-critical network is when financial transactions must be completed promptly such as, e.g., online stock trading. At least the following factors contribute to the complexity of such networks: unstable end-to-end connectivity between a source device and a destination device in such a network, a limited bandwidth allowance per source and/or per destination, strict prioritization requirements, real-time requirements, and traffic and protocols restrictions because of special purpose network devices (e.g., gateways, encoders, firewalls, and so on). Furthermore, such networks demand support for non-compromised requirements, such as bandwidth management over limited bandwidth, quality of service for every packet, no latency, transparency, and so on.

The complexity of the time-critical networks and of modern communication networks further limits the ability to perform real-time inspection of network traffic that allows identification of abnormal events, such as abnormal network behavior and abnormal data traffic. This presents a significant limitation, as misuse of network resources either by malicious attackers or faulty design of such resources cannot be detected and mitigated in real-time. As many new types of security threats are introduced frequently, the risk to resources of time-critical and/or mission-critical networks has significantly increased.

Prior art techniques for detection of abnormal events are predominately based on analyzing recorded log files or analyzing packets of specific protocols where the context of the data is known. Detection based on logged files can only be performed after the attacks occurred. Thus, such logged file detection is not suitable for time-critical networks. Analyzing packets of known protocols (e.g., application layer protocols) requires prior knowledge of a protected resource (e.g., a web application) and the context of the data to compare inspected packets to an established baseline. As vast amounts of data are being transferred, it is an immense challenge to perform such an inspection in real-time.

It would be therefore advantageous to provide a solution that would allow real-time inspection and detection of traffic in data networks including special-purpose data networks. It would be further advantageous if the proposed solution would be fully compliant with existing standard network protocols and devices and fully transparent to other network entities.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

The disclosure relates in various embodiments to a method for inspecting frames in a communication network. The method comprises transparently intercepting frames flowing in the communication network; inspecting each of the intercepted frames to detect at least one abnormal event; upon identifying an intercepted frame as including at least one abnormal event, determining if at least one network service can be assigned to the abnormal event identified in the intercepted frame in order to mitigate the abnormal event; and processing each intercepted frame according to at least one service associated with the frame.

The disclosure also relates in various embodiments to a network gateway comprising an interface to a network for monitoring traffic flow; a processor; and a memory connected to the processor, the memory contains instructions that when executed by the processor, the network gateway is configured to: transparently intercept frames flowing in the communication network; inspect each of the intercepted frames to detect at least one abnormal event; upon identifying an intercepted frame as including at least one abnormal event, determine if at least one network service can be assigned to the abnormal event included in the intercepted frame in order to mitigate the abnormal event; and process each intercepted frame according to the at least one service being associated with the frame.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a network diagram of a data network used to describe the various disclosed embodiments.

FIG. 2 is a schematic block diagram of the network gateway discussed in FIG. 1.

FIG. 3 is an example for a service table in accordance with an embodiment.

FIG. 4 is a flowchart describing the operation of a network gateway according to an embodiment.

FIG. 5 is a flowchart illustrating a method for traffic inspection according to an embodiment.

FIG. 6 is a flowchart illustrating a method for detecting abnormal network events according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

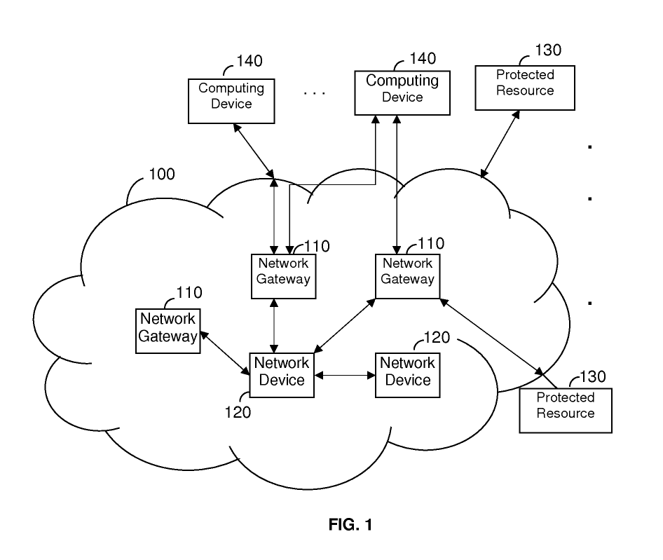

FIG. 1 is an exemplary diagram of a data network 100 used to describe the various disclosed embodiments. The data network 100 includes a plurality of network gateways 110 configured to inspect real-time traffic as discussed in greater detail below, as well as a plurality of network devices 120. It should be noted that, although only three network gateways 110 and two network devices 120 are shown in FIG. 1, differing numbers of these components may be utilized without departing from the scope of the disclosed embodiments.

To the network 100 there are connected a plurality of computing resources including resources to be protected (hereinafter protected resources 130) and computing devices 140 through which the protected resources 130 can be accessed. It should be noted that, although only two protected resources 130 and two computing devices 140 are shown in FIG. 1, differing numbers of these components may be utilized without departing from the scope of the disclosed embodiments. The protected resources 130 may include, but are not limited to, a web server, an application server, a datacenter, a cloud computing resource, an application (e.g., a web application), a database, and the like. In a preferred implementation, the protected resource 130 can execute time-critical and/or mission-critical tasks. A computing device 140 may be, but is not limited to, a computing terminal, a personal computer, a smart phone, a tablet computer, and any other computing device with access to the data network 100.

The data network 100 may include be a wired network, a wireless network, a cellular network, a local area network, a wide area network, an enterprise network, and any combination thereof. In certain implementations, the data network 100 may include two or more sub-networks (not shown) connected with each through a data link (also not shown in FIG. 1). Such a link may be either a wireless link or a wired link configured to carry UDP traffic. Examples for such sub-networks include a ground sub-network, an aerial sub-network, and the like.

Each network gateway 110 can be connected at any point in the network 100. That is, a gateway 110 can be connected to a network device 120, a protected resource 130, and a computing device 140. A network gateway 110 is typically connected in-line of traffic. A network gateway 110 is a transparent device that monitors traffic flows between two end-points (e.g., a network device and a protected resource, a protected resource and a computing device, a network device and a computing device, and so on).

In an embodiment, each network gateway 110 is configured to inspect the data frame flow between two endpoints and to process the frames based on predefined events, as described in further detail herein below. Acting as a transparent device, the network gateway 110 has no IP address that other network entities should address their frames to (an IP address may be used only for maintenance and configuration purposes). The elements connected to the network merely send frames to each other while the gateway 110 intercepts these frames at the data link layer. In an embodiment, the intercepted frames are layer-2 frames as defined by the OSI model. Examples for communication protocols that can be used for such protocols include, but are not limited to, IEEE 802.3, IEEE 802.11, and IEEE 802.16, and the like. In certain implementations, a network gateway 110 may be integrated in a network device 120, a protected resource 130, and a computing device 140.

According to the disclosed embodiments, each network gateway 110 is configured to perform one or more of the following functions: real-time traffic inspection, real-time recording and playback of data, and identification and analysis of abnormal events in real time.

As will be discussed in detail below, the identification of abnormal events may be based on a model created to describe the monitored traffic. The model is created using a set of identified bifurcation points and corresponding data correlated variation (covariance). A network model is created based on one or more catastrophe functions used to detect abnormal events by analyzing degenerate critical points of the function. The degeneracy of such events can be described by expanding a potential function in small perturbation of the parameters. That is, if the abnormal events are structurally stable (i.e., not accidental), such events may be considered as unexpected network behavior and/or unexpected traffic (data packets).

A network model is created based on a catastrophe theory. The catastrophe theory defines that small changes in certain parameters of a nonlinear system can cause equilibria to appear or disappear, or to change from attracting to repelling and vice versa, leading to large and sudden changes of the behavior of the system. However, in a larger parameter space, such changes (identified by bifurcation points) tend to occur as part of well-defined qualitative geometrical structures. The analysis of the abnormal event using the created network model can discover the root cause of the abnormal traffic and define a robust set of access lists and security rules. The disclosed embodiments for real-time identification and analysis of events are discussed in greater below.

In certain embodiments, the network getaway 110 can perform at least one mitigation or correction action on a detected abnormal event. Such actions include, but are not limited to, dropping packets of abnormal traffic, recording and reporting events, and seamlessly changing the traffic. The mitigation and correction actions can be defined in the service table maintained by the gateway 110. An exemplary service table is described further herein below with respect to FIG. 3.

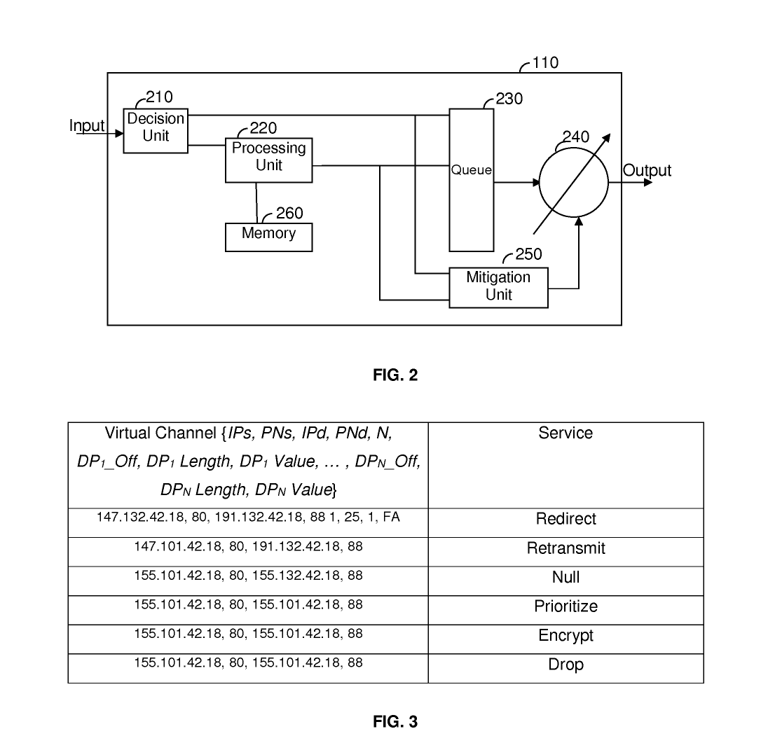

FIG. 2 shows an exemplary and non-limiting block diagram of the network gateway 110 implemented in accordance with one embodiment. The network gateway 110 includes a decision unit 210, a processing unit 220, a queue 230, a traffic shaper 240, a mitigation unit 250, and a memory 260. The network gateway 110 is configured to inspect each incoming data frame, detect network events, and determine, based on the network events, what type of services should be associated with the frames. A network event may be, for example, a predefined data pattern, a predefined frame sequence, a virtual channel, any combination of network addresses, a detection of an abnormal event, and the like. A virtual channel carries traffic that always originates from the same source IP address and port number and directed to the same destination IP address and port number.

In an embodiment, the virtual channel is defined as a combination of source/destination IP addresses, port numbers, and a number of N of data patterns (DP₁, . . . , DP_{N}). For each data pattern (DPᵢ) a combination of an offset of the data pattern in the frame (DPᵢ_{_{—}}Off), the data pattern length (DPᵢ_{_{—}}length), and a DPᵢ_{_{—}}length value are used as part of the virtual channel definition. The DPᵢ_{_{—}}Off represents the location of the first data pattern in the frame. An exemplary values for a first virtual channel are listed in FIG. 3.

The services that can be associated with a frame may include, but are not limited to, retransmission of the frames (i.e., guaranteed delivery), redirection of frames to one or more destinations, address resolution (e.g., acting as an ARP proxy), protocol conversion, bandwidth management, prioritization, encryption and decryption of data (by implementing, for example, an IPSec protocol), signalling, alarming, and so on. In one embodiment, the services include one or more mitigation actions. These mitigation actions are performed by the mitigation unit and include, but are not limited to, dropping of packets, recording and reporting abnormal events, and performing packet intervention. The packet intervention includes changing values of the packets to meet a normal pattern or value as determined by the network model. The packet intervention is performed seamlessly while meeting the protocol requirements.

The protocol conversion service enables conversion of an Internet protocol (IP) to legacy protocols such as MIL-STD-1553; Hotlink; serial protocols, such as RS 485, RS 422, RS 235; and the like. In addition, this service enables conversion of an analog video format to a digital format compliant with, for example, the H.264 and MPEG-4 formats. It is appreciated that the network gateway 110 can be easily adapted to support other type of services and that the services listed above are merely examples.

The decision unit 210 is configured to receive an incoming frame relayed by a network device 120 and determines if further processing is required for that frame. The decision is made using a service table stored in the decision unit 210 (e.g., the service table described further herein below with respect to FIG. 3). The table defines, for each network event, which service(s) should be associated with frames that comply with the detected event.

To ensure transmission of the frames in order while the decision unit 210 evaluates a frame, no new frames are received. It is appreciated that the evaluation of frames typically includes a look-up table operation to locate the respective virtual channel entry. Thus there is no latency involved with the operation of the decision unit 210.

Frames that should be processed are input to the processing unit 220, which handles each frame according to the service(s) associated with the frames. Each service requires different handling by the processing unit 220. For example, to guarantee reliable delivery, a copy of the frame is retransmitted a predefined number of times. Redirection of a frame includes modifying the destination IP address and port number to specify the new destination, withholding transmission of dropped frames, converting of unicast frames to multicast frames, and prioritizing of frames by inserting “prioritized” frames into the head of the queue 230. In fact, processed (non-prioritized) frames are saved in the queue 230 according to the order in which they were received.

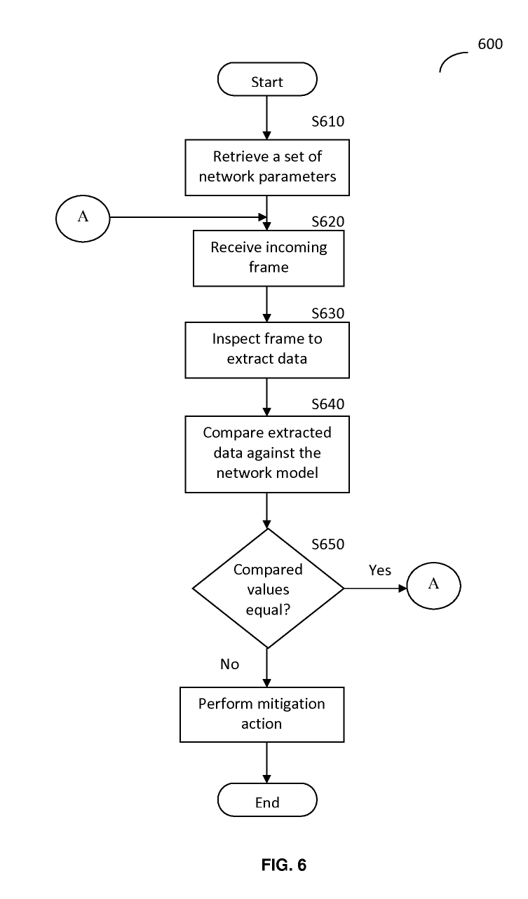

According to the disclosed embodiments, the processing unit 220 is further configured to inspect incoming frames to create a network model based on traffic flows through the network gateway 110. The processing unit 220 is further configured to detect abnormal events in incoming frames by comparing such frames to the network model. The operation of the processing unit 220 through a learning phase (creation of the data model) and a mitigation phase (detection of abnormal events) are discussed in greater detailed below with respect to FIGS. 5 and 6, respectively. The memory 260 may maintain the generated network model, a set of network parameters utilized to model the network, and/or recorded abnormal events.

The traffic shaper 240 is configured to retrieve frames stored in the queue 230 and to perform the task of bandwidth management to meet the available bandwidth on the data link. Typically, the traffic shaper 240 is configured to buffer a set of frames, thereby imposing additional delay on those frames such that they conform to a predetermined constraint of the data link's bandwidth. This ensures elimination of burst transmissions and transmitting data at a transfer rate which is no higher than the permitted transfer rate.

It should be noted that each of the decision unit 210, the processing unit 220, and the mitigation unit 250 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

Each of the units 210, 220, and 250 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

An exemplary and non-limiting service table is provided in FIG. 3, where the network event is a virtual channel. Entries in the service table designated as “null” indicate that no processing is required on frames received on the respective virtual channels. Such frames are forwarded directly to the queue 230. The service table is preconfigured and can be dynamically updated by a user (e.g., a system administrator).

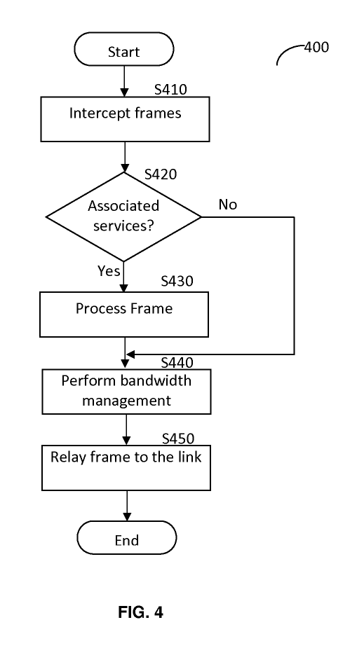

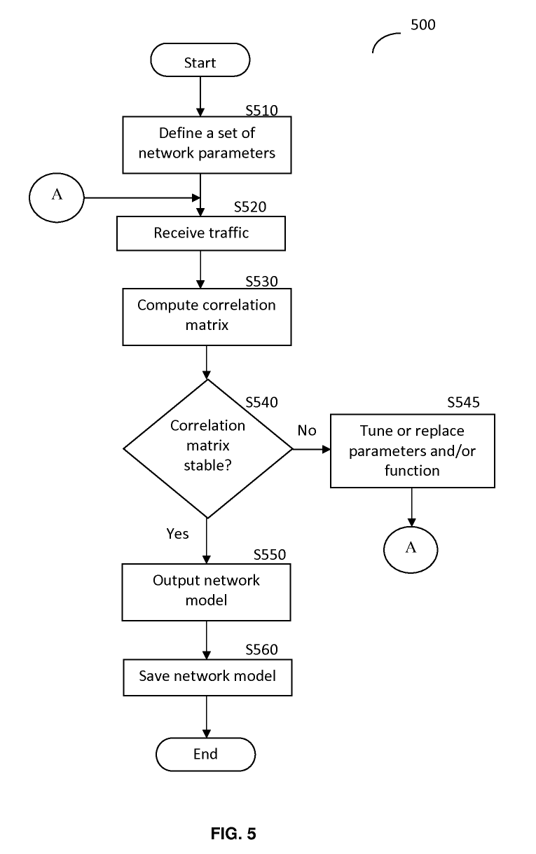

FIG. 4 shows an exemplary and non-limiting flowchart 400 describing the operation of the network gateway 110 in accordance with an embodiment. At S410, a frame sent from a network device (e.g., the network device 120) is intercepted. At S420, a check is made to determine if one or more predefined services are associated with a frame and, if so, execution continues with S430; otherwise, execution continues with S440. As mentioned above, the check is performed by comparing a virtual channel of the frame and/or a network event against the service table. At S430, the frame is processed according to service(s) associated with the frame. The processing tasks include, but are not limited to, redirection of the frame, dropping the frame, prioritizing the frame, retransmission of the frame, protocol conversion, and address resolution. In a preferred embodiment, the processing further includes generating alarms and signalling the users based on detected network events through the processing step. For example, a network event may be a frame that matches a predefined sequence and, thus, if such a frame is detected, an alarm may be generated. As another example, the gateway 110 may signal the user if a frame is sent to or from an unknown address, which is an address that is not configured in the gateway. At S440, bandwidth management is performed by shaping “processed” and “non-processed” frames. Thereafter, at S450, frames are relayed to the data link.

FIG. 5 shows an exemplary and non-limiting flowchart illustrating the learning phase of operation of the network gateway 110 for traffic inspection according to one embodiment. The method can be performed by each network gateway 110 configured to perform the disclosed embodiments. It should be noted that for detection of abnormal events, first a learning phase takes place during which a network model is created. Then, a detection phase takes place during which incoming traffic is compared to the created data model.

At S510, a set of network parameters utilized to create a network model representing the network behaviour are defined. In an embodiment, the set of network parameters include statistical and non-statistical parameters. The parameters utilized to create the model can be selected, for example, by a user from a pre-configured collection of parameters. Parameters can be added, removed, or tuned during the creation of the network model.

Examples for network parameters include frame size, frequency of frames, a network address (source and/or destination address of the frame), a value of a certain word (byte or bytes) within a frame, the frequency of appearance of such word across multiple frames, and so on. The word can be any field in the header and/or payload of the frame. The context or meaning of such a word is not known during the inspection.

In an embodiment, the word serving as a network parameter can be identified as a byte number with the frame, can be offset from the beginning of the frame, and so on. In another embodiment, the word serves as a parameter that can be extracted through a predefined mask vector. A XOR operation between the frame and the mask vector would result in the word of interest. The mask vector can be tuned during the creation of the network model. It should be noted that the set of parameters include a plurality of words to be examined. As an example, the words in located in bytes 5, 7, and 11 can be selected as the parameters. Other network parameters, such as frames' sizes and their frequencies can be considered as well. The number of selected parameters determines the accuracy of the network model. A statistical parameter is a statistical measure of a parameter. For example, statistical parameters may include averages, maximum and minimum values, divisions from the average values, and so on.

At S520, traffic that flows through the network gateway 110 is received. In an embodiment, layer-2 frames are received and inspected. It should be noted that any data field in a received frame can be inspected. The data field may be part of the header of the frame and/or of the payload of the frame. It should be noted that monitoring or inspection of the data can be performed in higher protocol layers such as, for example, layer 3 through layer 7 of the OSI model. The inspection of data related to higher protocol layers is performed without the need to have prior knowledge of the protocol type and/or the context of the data being inspected. As an example, if a layer-2 frame flowing through the network gateway 110 encapsulates a layer-7 type protocol such as, e.g., an FTP, a legacy protocol, and the like, the inspection of data related is by the checking of a certain offset within the payload of the frame. For example, a header of the FTP protocol will be identified with 32 bytes from the beginning of the header frame. The recognition of the header can be based on identification of repeating patterns across a plurality of frames.

At S530, a correlation matrix is computed to determine correlation among values of the set of network parameters selected to model the behaviour of the network. The purpose of the correlation matrix is to identify the correlation between the various parameters values.

As a non-limiting example, four parameters (P1, P2, P3, and P4) are selected to model the network behaviour. The parameter P1 is the frame size, P2 is a destination address of the frame, P3 is a byte number 15 in the frame, and P4 is a byte number 27 in the frame. The correlation matrix is a 4 by 4 matrix. The computed values of the matrix identify a correlation between values of each parameter across multiple frames, and correlation between each two parameters. For instance, a correlation between the destination address (P2) and byte number 27 (P4), byte number 15 (P3) and byte number 27 (P4), and so on. Once the correlation matrix is computed, one or more catastrophe functions are applied in order to identify the presence and the type of a catastrophe. In an exemplary embodiment, a Chebyshev Polynomial with a configurable order of polynom is used as the catastrophe function. Other catastrophe functions may be based on Mac-Laurin functions. The correlation matrix can be computed using techniques discussed in the related art. As a non-limiting example, values of a correlation matrix (COR) of the variance-covariance matrix COV can be computer using the following equation:

$${cor}_{i , j} = \frac{{cov}_{i , j}}{\sqrt{{cov}_{i , i}} \sqrt{{cov}_{j , j}}}$$

Typically, a covariance matrix C should definitively satisfy the following: |Cij|²≦Cii Cjj for all indices i, j. That is, the absolute values of the entries of the corresponding correlation matrix do not exceed 1.

At S540, it is checked if the correlation matrix is stable, and if so execution continues with S550; otherwise, execution proceeds with S545. A stabilized matrix is achieved when the computed or observed correlations are the same over a predefined number of frames, a predefined time interval, or that a correlation value between at least two parameters exceeds a predefined threshold.

At S545, a determination is made if one or more of the selected parameters and/or the function utilized to compute the correlation matrix should be tuned or otherwise replaced. The determination may be based on which parameters affect the modelling of the networking and/or which catastrophe functions (e.g., a polynomial order) would converge the computation of the correlation matrix. Then, execution returns to S520.

At S550, based on the computed correlation matrix, the network model is output. This model defines the expected value, up to a predefined error, for each parameter, for each pair of parameters, or for a group of parameters selected to model the network behaviour. For example, when the value of destination address (P2) is ‘add_{—}1101,’ the expected value of byte number 15 is ‘4’. If no correlation is identified, a value can be set to null. At S560, the output network model is saved. In an embodiment, the output network model is saved in the network gateway 110. In an embodiment, the network model can be sent to other network gateways 110 that can inspect traffic directed to or originated from resources that receive or generate traffic so that generated model can be utilized. S560 ends the learning phase and the detection phase of abnormal events commences.

FIG. 6 shows an exemplary and non-limiting flowchart 600 illustrating a method for detecting abnormal network events according to one embodiment. The method may be performed by the network gateway 110 using a network model created by or that can be processed by the network gateway 110. The network model is typically saved in a memory of the network gateway 110.

At S610, a set of network parameters used for the creation of the network model is retrieved. At S620, an incoming frame is received. At S630, the received frame is inspected to extract the data related to the parameters retrieved at S610. For example, the values of the noted-above parameters P1, P2, P3, and P4 are extracted. At S640, the extracted values of each pair of parameters are compared against the network model, i.e., the correlation matrix. At S650, it is checked if the compared values are equal and, if so, execution continues with S620 where another frame is received; otherwise, execution continues with S660. It should be noted that S640 and S650 are performed for each pair of parameters.

Execution reaches S660 when values of at least one pair of parameters does not equal to the respective values in the network model. As the network model represents a normal behaviour of the network, the inequality represents abnormal event and/or traffic. At S660, at least one mitigation action is performed. The mitigation action may include dropping the frame or reporting and recording the abnormal event and/or traffic. In an embodiment, the mitigation action includes seamlessly changing the frame's data to meet the values in the model. After changing the packet value, the packet is relayed back to the network. It should be noted that the frame's data is changed in such manner that the modified frame complies with the layer-2 protocol requirements.

The embodiments disclosed herein can be implemented as any combination of hardware, firmware, and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

Also, it should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for real-time inspecting frames in a communication network, comprising:
transparently intercepting frames flowing in the communication network;
inspecting each of the intercepted frames to detect at least one abnormal event;
upon identifying an intercepted frame as including at least one abnormal event, determining if at least one network service can be assigned to the abnormal event identified in the intercepted frame in order to mitigate the abnormal event; and
processing each intercepted frame according to at least one service associated with the frame.

2. The method of claim 1, further comprising:
generating a network model of the communication network based on the intercepted frames to detect the at least one abnormal event.

3. The method of claim 2, wherein generating the network model further comprises:
selecting a set of network parameters to model the communication network;
computing a correlation matrix to determine the correlation between values of each pair of the set of network parameters; and
outputting the network model as the correlation matrix, once the correlation matrix is stable.

4. The method of claim 3, wherein the context of each network parameter is unknown.

5. The method of claim 3, further comprising:
applying at least one catastrophe function to the computed correlation matrix to determine a catastrophe type.

6. The method of claim 5, further comprising:
stabilizing the correlation matrix by modifying at least one of: the set of network parameters, and the at least one catastrophe.

7. The method of claim 3, wherein inspecting the intercepted frames to detect at least one abnormal event further comprises:
comparing an incoming frame against the network model; and
determining at least one abnormal event when a value of at least one network parameter is not equal to a value of the network model.

8. The method of claim 1, wherein the at least one network service comprises at least one of: relaying the processed frame back to the communication network, redirecting the processed frame to one or more destinations, dropping the processed frame, recoding the abnormal event, signalling, and alarming.

9. The method of claim 8, wherein the at least one network service further comprises changing the value of the at least one network parameter that is not equal to a value designated in the network model.

10. The method of claim 1, wherein the intercepted frames are layer-2 frames.

11. The method of claim 1, wherein the communication network is any one of: a time-critical network, and a mission-critical network.

12. A non-transitory computer readable medium having stored thereon computer executable code which, when executed, causes a processing system to perform the method of claim 1.

13. A network gateway, comprising:
an interface to a network for monitoring traffic flow;
a processor; and
a memory connected to the processor, the memory contains instructions that when executed by the processor, the network gateway is configured to:
transparently intercept frames flowing in the communication network;
inspect each of the intercepted frames to detect at least one abnormal event;
upon identifying an intercepted frame as including at least one abnormal event, determine if at least one network service can be assigned to the abnormal event included in the intercepted frame in order to mitigate the abnormal event; and
process each intercepted frame according to the at least one service being associated with the frame.

14. The network gateway of claim 13, further configured to:
generate a network model of the communication network based on the intercepted frames to detect the at least one abnormal event.

15. The network gateway of claim 14, further configured to:
select a set of network parameters to model the communication network;
compute a correlation matrix to determine the correlation between values of each pair of the set of network parameters; and
output the network model as the correlation matrix, once the correlation matrix is stable.

16. The network gateway of claim 15, wherein the context of each network parameter is unknown.

17. The network gateway of claim 15, wherein at least one catastrophe function is applied to the computed correlation matrix to determine the catastrophe function.

18. The network gateway of claim 17, further configured to:
stabilize the correlation matrix by modifying at least one of: the set of network parameters, and the at least one catastrophe function.

19. The network gateway of claim 15, further configured to:
compare an incoming frame against the network model; and
determine at least one abnormal event when a value of at least one network parameter is not equal to a value of the network model.

20. The network gateway of claim 13, wherein the at least one network service comprises at least one of: relaying the processed frame back to the communication network, redirecting the processed frame to one or more destinations, dropping frames, recoding and abnormal event, signalling, and alarming.

21. The network gateway of claim 20, wherein the at least one network service further comprises: changing the value of the at least one network parameter that is not equal to a value designated in the network model.

22. The network gateway of claim 13, wherein the intercepted frames are layer-2 frames.

23. The network gateway of claim 13, wherein the communication network is any one of: a time-critical network, and a mission-critical network.
